(19) United States
(12) Patent Application Publication
(10) Pub. No.: US 2003/0004832 A1
(43) Pub. Date: Jan. 2, 2003

(54) Consumable-supplies purchase order method and system, customer equipment, and purchase order processing apparatus

(76) Inventors: Haruo Kamimoto, Kanagawa (JP); Kenji Kuwana, Chiba (JP); Takehiro Nishiura, Tokyo (JP); Yayoi Katagiri, Saitama (JP); Hisashi Miyagawa, Shizuoka (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 10/166,688

(22) Filed: Jun. 12, 2002

(30) Foreign Application Priority Data
Jun. 13, 2001 (JP) 2001-179269

(51) Int. Cl. G06F 17/60

(52) U.S. Cl. 705/26

(57) ABSTRACT

In a consumable-supplies purchase order method for a system including a customer equipment and a purchase-order processing apparatus connected via a communication network, a consumable-supplies condition detection unit detects whether a quantity of consumable supplies in the customer equipment is less than a given reference quantity. A consumable-supplies purchase order from the customer equipment is transmitted to the purchase-order processing apparatus when the quantity of the consumable supplies is less than the reference quantity. An order-reception message, sent by the purchase-order processing apparatus, is received when the purchase order is received at the purchase-order processing apparatus. An indication of completion of the purchase order is displayed on an operation panel after the order-reception message is received.

### BACKGROUND OF THE INVENTION

1. Field of The Invention

The present invention relates to a consumable-supplies purchase order method, a consumable-supplies purchase order system, a customer equipment and a purchase order processing apparatus.

2. Description of The Related Art

Conventionally, the supplementing of consumable supplies to customer equipment is performed each time the necessity of the customer equipment takes place, while the customer is required to grasp the current situations of the consumable supplies in the customer equipment. For example, when toner runs short in the customer equipment, such as a copier and a printer, the customer gives by telephone or facsimile a purchase order for the toner to a predetermined supply center. Moreover, the delivery of only a fixed quantity of consumable supplies to the customer is also periodically performed according to the contract.

However, when the above method of placing a purchase order for consumable supplies to the supply center each time the necessity arises, while the customer himself grasps the situation of the consumable supplies is used, there is a problem that the customer is unaware of the necessity of supplementing the consumable supplies until the consumable supplies in the customer equipment are lost completely.

Moreover, since the customer worries about the unawareness of the necessity of supplementing the consumable supplies or wishes to reduce a complicated purchase ordering of the consumable supplies, the placement of a purchase order for a large quantity of the consumable supplies is performed beforehand. Consequently, a problem that the customer has to hold useless stock of consumable supplies will arise.

Moreover, if the delivery of only a fixed quantity of the consumable supplies to the customer is performed according to the contract, then the problem that the consumable supplies run short soon arises. To avoid this problem, if the delivery of a large quantity of the consumable supplies to the customer is performed periodically by the contract, the problem that the customer has to hold the useless stock of the consumable supplies will arise.

### SUMMARY OF THE INVENTION

An object of the present invention is to provide an improved consumable-supplies purchase order method and system in which the above-described problems are eliminated.

Another object of the present invention is to provide a consumable-supplies purchase order method that allows the customer to place a purchase order for consumable supplies in the customer equipment quickly and exactly, thereby reducing the unnecessary stock of consumable supplies.

Another object of the present invention is to provide a consumable-supplies purchase order system that allows the customer to place a purchase order for consumable supplies in the customer equipment quickly and exactly, thereby reducing the unnecessary stock of consumable supplies.

Another object of the present invention is to provide a customer equipment that allows the customer to place a purchase order for consumable supplies in the customer equipment quickly and exactly, thereby reducing the unnecessary stock of consumable supplies.

Another object of the present invention is to provide a purchase-order processing apparatus that allows the customer to place a purchase order for consumable supplies in the customer equipment quickly and exactly, thereby reducing the unnecessary stock of consumable supplies.

The above-mentioned objects of the present invention are achieved by a consumable-supplies purchase order method for a system including a customer equipment and a purchase-order processing apparatus that are connected via a communication network, comprising the steps of: detecting at a consumable-supplies condition detection unit of the customer equipment whether a quantity of consumable supplies in the customer equipment is less than a given reference quantity; transmitting a consumable-supplies purchase order from the customer equipment to the purchase-order processing apparatus when the quantity of the consumable supplies is less than the reference quantity; receiving an order-reception message sent by the purchase-order processing apparatus when the purchase order is received at the purchase-order processing apparatus; and displaying an indication of completion of the purchase order on an operation panel of the customer equipment after the order-reception message is received.

The above-mentioned objects of the present invention are achieved by a consumable-supplies purchase order system including a customer equipment and a purchase-order processing apparatus that are connected via a communication network, the customer equipment comprising: a consumable-supplies condition detection unit which detects whether a quantity of consumable supplies in the customer equipment is less than a given reference quantity; a transmission unit which transmits a consumable-supplies purchase order from the customer equipment to the purchase-order processing apparatus when the detection unit detects that the quantity of the consumable supplies is less than the reference quantity; a receiving unit which receives an order-reception message sent by the purchase-order processing apparatus when the purchase order is received at the purchase-order processing apparatus; and a displaying unit which displays an indication of completion of the purchase order on an operation panel of the customer equipment after the order-reception message is received.

The above-mentioned objects of the present invention are achieved by a customer equipment which is connected to a purchaseorder processing apparatus via a communication network in a consumable-supplies purchase order system, the customer equipment comprising: a main controller; a communication controller; and a consumable-supplies condition detection unit which detects whether a quantity of consumable supplies in the customer equipment is less than a given reference quantity, wherein the main controller causes the communication controller to transmit a consumable-supplies purchase order from the customer equipment to the purchase-order processing apparatus when the detection unit detects that the quantity of the consumable supplies is less than the reference quantity.

The above-mentioned objects of the present invention are achieved by a purchase-order processing apparatus which is connected to a customer equipment via a communication network in a consumable-supplies purchase order system, the purchase-order processing apparatus comprising: a purchase-order receiving unit which receives a consumable-supplies purchase order from the customer equipment; and an order response unit which transmits an order-reception message to the customer equipment in response to the purchase order, wherein the response unit transmits an order-reception message to the customer equipment when the purchase order from the customer equipment is received by the receiving unit, the order-reception message indicating the reception of the purchase order by the purchase order processing apparatus.

According to the consumable-supplies purchase order method and system of the present invention, the customer is allowed to place a purchase order for consumable supplies in the customer equipment quickly and exactly, thereby reducing the unnecessary stock of consumable supplies.

### BRIEF DESCRIPTION OF THE DRAWINGS

Other objects, features and advantages of the present invention will be apparent from the following detailed description when read in conjunction with the accompanying drawings.

FIG. 1 is a diagram showing the configuration of the consumable-supplies purchase order system of the present invention.

FIG. 2 is a diagram showing the configuration of a customer equipment.

FIG. 3 is a block diagram of an electric control system of a copier provided as the customer equipment.

FIG. 4 is a diagram showing an example of an information code.

FIG. 5 is a diagram showing an example of a transmission format.

FIG. 6 is a diagram showing the top surface of an operation panel of the copier.

FIG. 7 is a flowchart for explaining an automatic purchase order process performed by the consumable-supplies purchase order system of the present invention.

FIG. 8 is a flowchart for explaining a customer-operation purchase order process performed by the consumable-supplies purchase order system of the present invention.

FIG. 9A through FIG. 9D are diagrams for explaining examples of message on the display of the operation panel.

FIG. 10 is a diagram for explaining another example of message on the display of the operation panel.

FIG. 11 is a diagram for explaining another example of message on the display of the operation panel.

FIG. 12 is a diagram showing the configuration of the purchase order processing apparatus of the present invention.

FIG. 13 is a block diagram for explaining the main functions provided by the purchase order processing apparatus.

FIG. 14 is a diagram for explaining the main databases contained in the purchase order processing apparatus.

FIG. 15 is a diagram for explaining one example of the consumable-supplies purchase order panel.

### DETAILED DESCRIPTION OF PREFERRED EMBODIMENTS

A description will now be provided of preferred embodiments of the present invention with reference to the accompanying drawings.

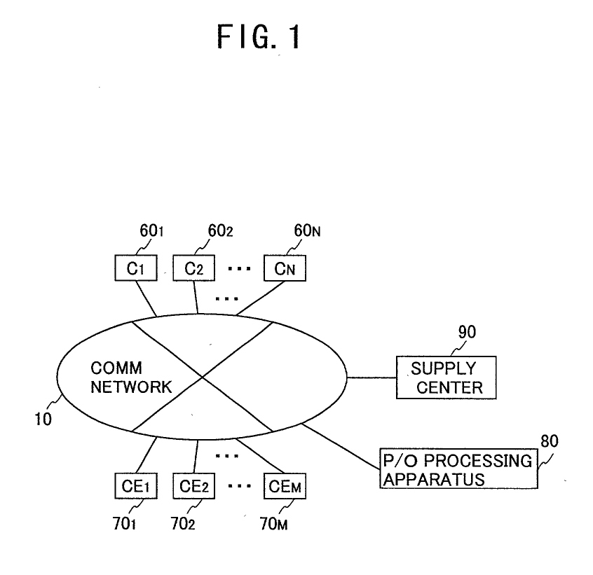

FIG. 1 shows the configuration of the consumable-supplies purchase order system of the present invention. As shown in FIG. 1, the consumable-supplies purchase order system includes a communication network (COMM NETWORK) 10, a plurality of customer equipment (C₁) 60₁ through customer equipment (C_{N}) 60_{N} which are arranged at the customer premises, a plurality of CE (customer engineer) terminal 70₁ through CE terminal 70_{M}, a purchase order (P/O) processing apparatus 80, and a supply center 90.

Alternatively, the purchase order processing apparatus 80 and the supply center 90 may be provided as a single apparatus. Moreover, the plurality of customer equipment 60₁-60_{N} and the plurality of CE terminals 70₁-70_{M} may be provided as clients on the communication network 10, and the purchase order processing apparatus 80 and the supply center 90 may be provided as a server on the communication network 10.

The communication network 10 is a data communication network such as the Internet or a public telephone network, and it is a communication network for mobile terminals and/or fixed terminals. The plurality of customer equipment 60₁-60_{N} are connected to the purchase order processing apparatus 80 through the communication network 10. Alternatively, the plurality of customer equipment 60₁-60_{N} may be directly connected to the purchase order processing apparatus 80 via a leased line local area network that is different from the communication network 10.

The plurality of customer equipment 60₁-60_{N} are, for example, printers, copiers or facsimile machines for the corporate or home use that are provided at the customer premises. Each of the plurality of customer equipment 60₁-60_{N} automatically transmits a request for delivery of consumable supplies (or the sending of a consumable-supplies purchase order) to the purchase order processing apparatus 80 through the communication network 10 when the consumable supplies of the customer equipment run short or the quantity of the consumable supplies becomes below a predetermined quantity.

The purchase-order processing apparatus 80 receives the request for delivery from the customer equipment through the communication network 10 (the receiving of purchase order information). The purchase-order processing apparatus 80 sends the purchase order information to the supply center 90 based on the received request. The supply center 90 delivers the consumable supplies to the customer in response to the purchase order information received from the purchase order processing apparatus 80.

The CE terminals 70₁-70_{M} are terminals that are owned by the respective customer engineers, and they may be fixed terminals or mobile terminals. In the following description, it is supposed that the CE terminals 70₁-70_{M} are portable telephones which are capable of connecting with the Internet and can receive and transmit an e-mail through the Internet. Moreover, in the following description, it is supposed that the plurality of customer equipment 60₁-60_{N} are copiers.

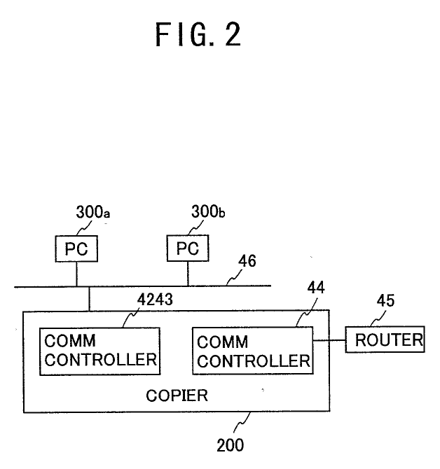

FIG. 2 shows the configuration of a copier 200 that is provided as one of the plurality of customer equipment 60₁-60_{N} in FIG. 1. The copier 200 is provided as the customer equipment, and configured so that it can print the printing data when the print command and the print data are received from host computers 300a and 300b, such as PC (personal computers), through a LAN 46 and a communication controller 4243 (which includes a parallel I/F controller 42 and an LAN controller 43 as described below). In addition, the copier 200 is a digital copier and can reproduce the copy of an original document.

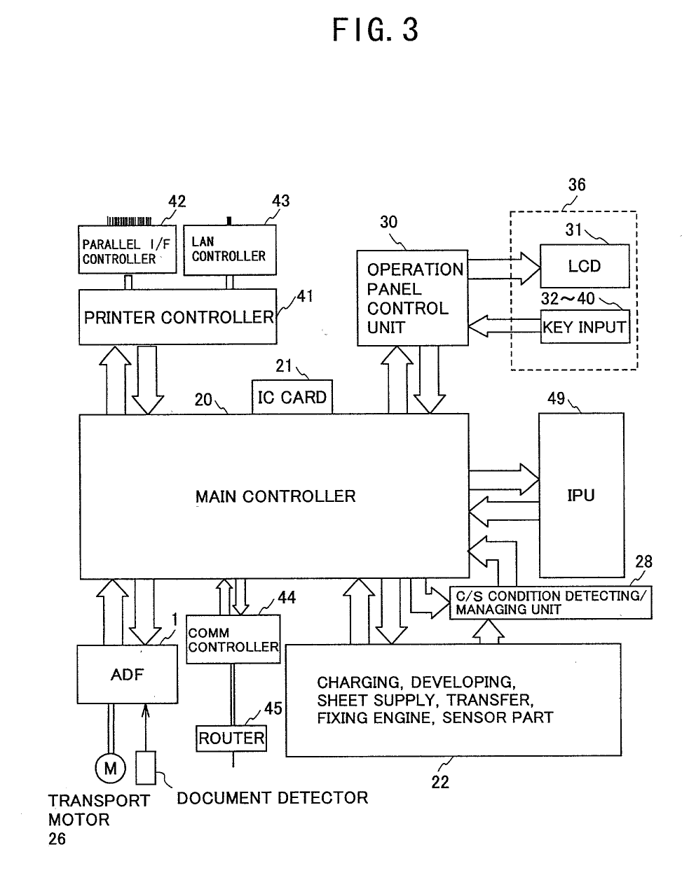

FIG. 3 shows an electric control system of the copier 200 in FIG. 200. As shown in FIG. 3, the electric control system of the copier 200 includes a main controller 20 as the center control device. The main controller 20 controls the entire copier 200. The main controller 20 is connected to the distributed control devices. The distributed control devices include an image-processing unit (IPU) 49 which performs the scanner control, the writing control to write an original image to an image memory and the imaging-related control with the image memory, an operation panel control part 30 which controls the operational setting data display to the customer and the function setting input from the customer, an automatic document feeder (ADF) 1, and a charging/developing/sheet supplying/transfer/fixing engine/sensor part 22. Control signals and state indicating signals related to the mechanical parts are exchanged between each distributed control device and the main controller 20 when the necessity arises. Moreover, a main motor for transporting of a sheet and various clutches are provided in the drivers (not shown in FIG. 3) of the main controller 20. In the charging/developing/feeding/transfer/fixing engine/sensor part 22 includes electric circuits and control circuits which control the mechanical components which are provided to perform the charging of the photoconductor, the feeding of a copy sheet from the paper tray, the image exposure by the optical writing unit, the developing, the transfer, the fixing and the ejecting of the copy sheet. A paper size sensor which performs size detection is provided in the paper tray, and a size detecting circuit on the feeding control board of the paper tray detects the size of the copy sheet in the paper tray based on the signal from the sensor, and stores the paper size data. Moreover, a paper type sensor which detects whether the copy sheet is a plain paper, an OHP sheet or a tracing paper is provided in the paper tray, and the paper type sensor detects the type of the copy sheet on the feeding control board of the tray based on the detected signal of the sensor, and stores the paper type data. Other sensors are also provided in the vicinity of the paper tray and the sheet feeding mechanism, and their detection circuits are located on the feeding control board. The main controller 20 reads the detection data output by the judgment circuits and the detection circuits at a predetermined timing, and recognizes the operating condition of the sheet feeding part.

A printer controller 41 analyzes the image data and the print command which are received from an external device, deploys the image data to the bit map that can be printed, and sets a printing mode of the copier 200 by analyzing the command. In order to receive and copy the image data, the LAN controller 43 and the parallel I/F 42 are provided in the communication controller 4243.

A consumable-supplies (C/S) condition detection unit 28 refers to the data of the charging/developing/feeding/transfer/fixing engine/sensor part 22 if needed, and performs the detection and management of the condition of the consumable supplies. Based on the detection of the condition of the consumable supplies, the consumable-supplies purchase order information is sent from the copier 200 to the purchase order processing apparatus 80 through the communication controller 44 and the router 45 automatically or according to the instructions of the customer.

The consumable-supplies purchase order information is described by an information code. The information code is temporarily stored in the buffer (not shown) of the C/S condition detection unit 28, and then it is transmitted to the purchase order processing apparatus 80 using a predetermined transmission format suited to the network. Therefore, the contents of the purchase order information can be detected at the purchase order processing apparatus 80 by receiving the information code.

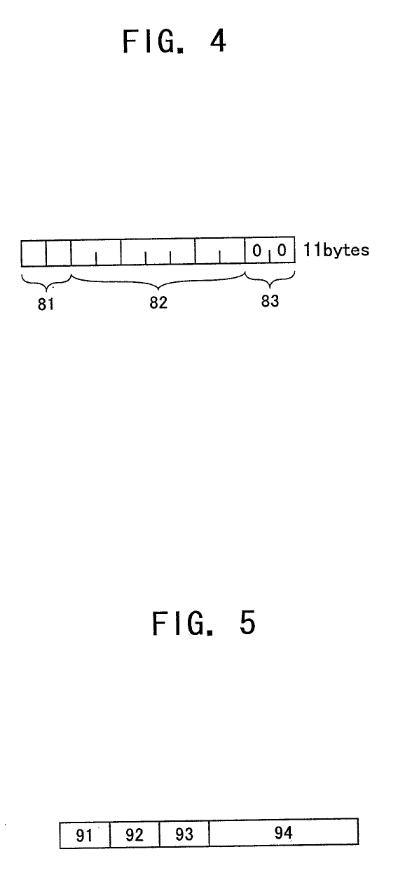

FIG. 4 shows an example of the information code. The information code in FIG. 4 includes 11 bytes of information. The first and second bytes of the information code are called a classification code 81. The classification code 81 will be described later. The third through ninth bytes of the information code are called a mode code 82. The mode code 82 indicates the contents of the consumable-supplies purchase order information. The tenth and eleventh bytes of the information code are called a return code 83. The purchase order processing apparatus 80 uses the return code 83 when sending an order-reception message back to the customer equipment (the copier 200). The return code 83 contains null data (“00”) when the purchase order information is transmitted from the copier 200 to the purchase order processing apparatus 80.

As for the classification code 81 of the information code in FIG. 4, the first byte of the information code is set to the value one (“1”) in the case where the purchase order information is automatically transmitted to the purchase-order processing apparatus 80. The first byte of the information code is set to the value two (“2”) in the case where the C/S condition detecting/managing unit 28 detects that the quantity of the consumable supplies is below a given reference quantity and the purchase order information is transmitted based on the result of the detection. The first byte of the information code is set to the value three (“3”) in the case where the customer places a purchase order for consumable supplies (not related to the consumable supplies in the customer equipment) and transmits the purchase order information arbitrarily.

FIG. 5 shows an example of a transmission format. The purchase order information, which is expressed with the abovedescribed information code in FIG. 4, is inserted into the transmission format in FIG. 5, and it is transmitted from the customer equipment to the purchase-order processing apparatus 80.

As shown in FIG. 5, the transmission format is comprised of a customer equipment identifier (ID) information 91, a destination address information 92, a date/time information 93, and a detailed information 94. In addition, the transmission format is not limited to the transmission format of FIG. 5. Any transmission format that is in conformity with the transmission circuit provided in the communication network may be used instead.

The customer equipment ID information 91 includes, for example, the model and machine number information of the customer equipment used by the customer. The destination address information 92 includes, for example, the address information of the purchase order processing apparatus 80. The date/time information 93 includes, for example, the clock information of the customer equipment used by the customer. The model and machine number information may include the address information in accordance with the 6th version of the Internet Protocol (IPv6).

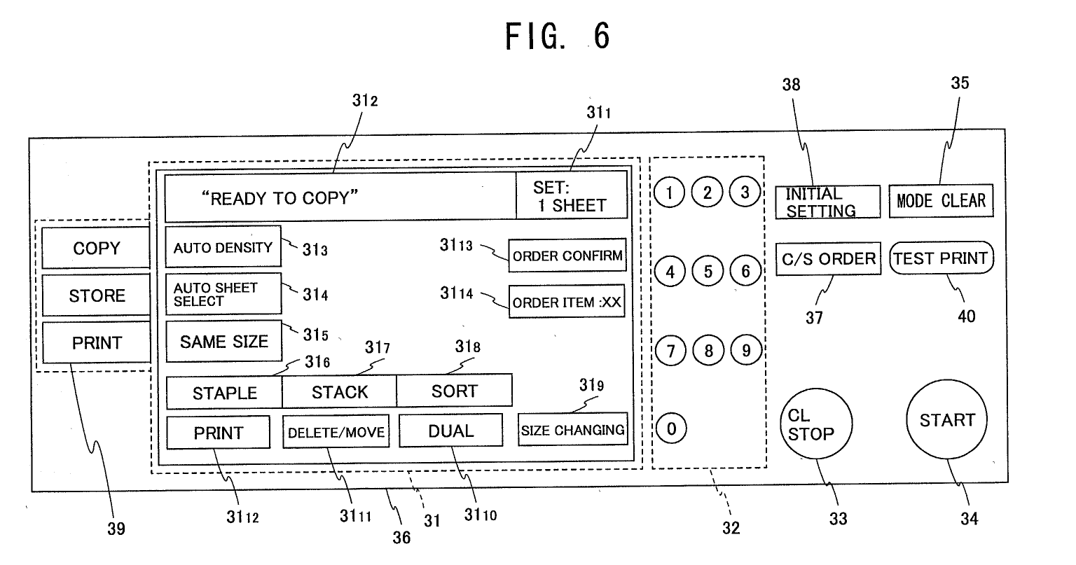

FIG. 6 shows the top surface of the operation panel 36 of the copier 200. The operation panel 36 includes a liquid crystal touch panel 31 (or LCD), ten keys 32, a clear/stop key 33, a start key 34, a mode clear key 35, a consumable-supplies purchase order key 37, an initial-setting key 38, a copy/store/print function display portion 39, and a test-print key 40. In addition, the C/S purchase order key 37 is pressed by the customer when the customer intends to transmit the purchase order information arbitrarily. When the key 37 is pressed, a purchase order message related to the consumable supplies is displayed on the liquid crystal touch panel 31. Alternatively, the key 37 may be provided in the liquid crystal touch panel 31, instead of the portion indicated in FIG. 6.

In the liquid crystal touch panel 31, the image forming device state message (indicated in the message display portion 312), the function keys (automatic density, automatic paper selection, same size, staple, stacking, sorting, printing, delete/move, dual, size changing, and so on), and the number of copies (indicated in the number-of-copies display portion 311) are displayed.

In the copy/store/print function display portion 39, the “copy” function is used to copy the image read by the document reading unit (the scanner), or the transmitted image, to the copy sheet. The “store” function is used to store the image data, which is read by the scanner in a different job and received from the host computer 300a or 300b, into the copier 200, and to carry out a printing of the image data after the end of execution of the preceding job. The “print” function is used to output the image data, which is received from the host computer 300a or 300b connected to the copier 200 through the LAN controller 43 and the parallel I/F 42, to the copy sheet (the print out) in accordance with the print command of the host computer by using the optical writing unit and the photoconductive imaging device of the copier 200.

The display state of the key block on the liquid crystal touch panel 31 changes to a screened display state when the customer touches the key. Moreover, when the details of the function must be specified (for example, when the size changing value is set), the setting message (the sub menu) about the detailed function setting information is displayed when the key is touched.

The condition of the liquid crystal touch panel 31 indicated in FIG. 6 is the waiting condition for receiving the printing instructions, which shows the present setting mode. In the message display portion 312 at the upper left position of the touch panel, the message, such as “ready to copy” or “wait”, is displayed. Moreover, the set number of copy sheets is displayed in the number-of-copies display portion 311.

Moreover, in the touch panel 31, various keys are indicated. For example, the automatic paper selection key 314 provided to set the automatic paper (size) selection function, and the automatic density key 313 provided to set the automatic image density selection function are indicated. The same size key 315 provided to set the same size magnification is indicated. The staple key 316 provided to set the stapling function is indicated. The stack key 317 provided to set the stacking function is indicated. The sorting key 318 provided to set the sorting function is indicated. The size changing key 319 provided to set the size changing magnification is indicated. The dual printing key 3110 provided to set the dual printing function is indicated. The delete/move key 3111 provided to set the delete/move function is indicated. The printing key 3112 provided to set the stamp/date/page printing function is indicated. When one of the keys on the liquid crystal touch panel 31 is touched, the display state of the selected key block changes to the screened display state.

When the purchase order processing apparatus 80 receives the purchase order for the consumable supplies sent by the automatic reporting of the customer equipment and sends the order-reception message to the customer equipment, an indication “ORDER CONFIRM” is displayed in the purchase order confirmation portion 3113. The customer can recognize from this indication that the purchase order information is automatically transmitted from the customer equipment to the purchase order processing apparatus 80. The purchase order item “XX” is displayed in the consumablesupplies purchase item portion 3114. If the purchase order confirmation portion 3113 is touched during the displaying of the purchase order item, the indication “ORDER CONFIRM” disappears and the information on the purport that the purchase order was checked to purchase order processing apparatus 80 is notified simultaneously. In addition, depending on the setup, this check operation can also be made unnecessary.

Moreover, when the purchase order of consumable supplies is made in the C/S purchase order portion 3114, the purchase order information on the consumable supplies is displayed on the operation panel. The contents of the newest purchase order are displayed briefly. For example, an indication “toner order” is displayed in the C/S purchase order portion 3114. In addition, the displaying of the C/S purchase order portion 3114 is continued until the delivery of the consumable supplies to the customer equipment is performed. Accordingly, the customer can know what kind of the consumable supplies in the customer equipment is currently ordered, by viewing the state of the touch panel 31.

Moreover, the purchase order information on the operation panel is continuously displayed until the ordered consumable supplies are supplied to the customer equipment. For example, the purchase order processing apparatus 80 serves to stop the displaying of the purchase order information when it receives the delivery information regarding the ordered supplies from either the supply center 90 or the customer engineer.

Moreover, those detailed information is displayed by touching the purchase order information portion to which the purchase order information is displayed.

A description will be given of the consumable-supplies purchase order that is transmitted from the customer equipment to the purchase-order processing apparatus 80 through the communication controller 14 and the router 45.

From the customer equipment, a purchase order for the consumable supplies in the customer equipment can be transmitted through the communication controller 44 and the router 45 to the purchase-order processing apparatus 80.

The C/S condition detecting/managing unit 28 detects whether the quantity of the consumable supplies in the customer equipment is less than a given reference quantity. There are two ordering methods (automatic purchase order; panel-operation purchase order) that the customer can select for placing a purchase order of the consumable supplies at the time of detection that the quantity of the consumable supplies in the customer equipment is below the reference quantity. Which one of the two ordering methods is taken is determined depending on the initial setting of the customer equipment.

A. Automatic Purchase Order

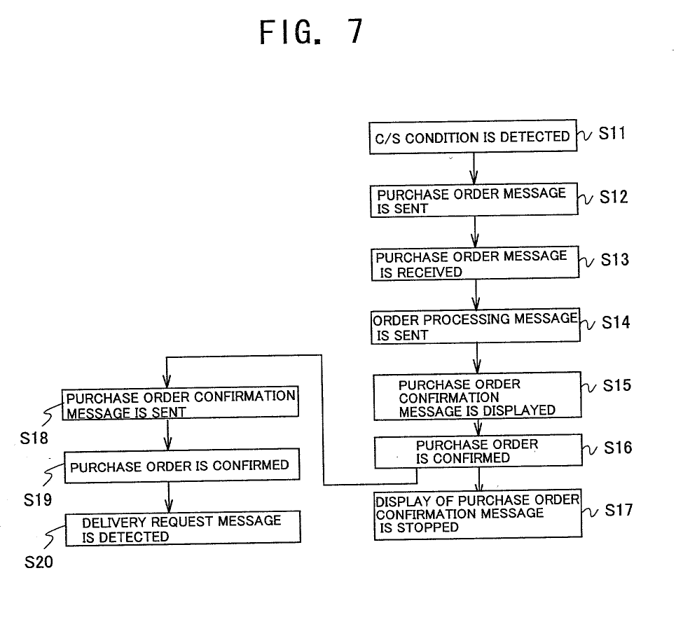

A description will be given of an automatic purchase order process that is performed by the consumable-supplies purchase order system of the present invention with reference to FIG. 7.

A-1. When the C/S condition detecting/managing unit 28 detects that the quantity of the consumable supplies in the customer equipment is less than a predetermined reference quantity (S11 of FIG. 7), the customer equipment transmits automatically the purchase order message related to the consumable supplies, to the purchase order processing apparatus (S12).

A-2. The purchase-order processing apparatus 80 receives the purchase order message sent by the customer equipment (S13), and transmits the order-reception message to the customer equipment, the order-reception message indicating that the purchase order from the customer equipment is received (S14).

A-3. When the order-reception message is received, the customer equipment performs the displaying of the order-reception confirmation indication (including the turn-on state of the display portion) to the purchase order confirmation portion 3113 of the operation panel (S15). Moreover, the ordered item of the purchase order information is displayed on the operation panel simultaneously. For example, the message indication “toner ordered” is displayed.

A-4. When the customer touches the purchase order confirm portion 3113 to confirm the reception of the purchase order with reference to the purchase order information (S16), the customer equipment transmits the order-reception confirmation message to the purchase order processing apparatus (S18), and stops the display of the purchase order confirmation (S17).

In addition, the confirmation of the purchase order may be asked to the administrator of the consumable-supplies purchase order in the customer site, and the response is awaited by the purchase order processing apparatus side. In this case it is not necessary to display the purchase order confirmation portion in the above step A-3. In addition, after the confirmation of the administrator is obtained, the purchase order processing apparatus 80 transmits the information on the purport that the confirmation of the purchase order can be taken, to the customer equipment, and the display of the purchase order confirmation portion is stopped.

A-5. When the purchase-order processing apparatus 80 receives the purchase order confirmation message from the customer equipment (S19), the purchase-order processing apparatus 80 transmits the delivery request message to the supply center 90 (S20).

Accordingly, when the automatic purchase order method is performed by the above system, the customer equipment places a purchase order for consumable supplies automatically, and the purchase order processing apparatus can take a confirmation of the purchase order of the customer. It is possible for the purchase order method and system of the present invention to provide good reliability and exactness, and it is possible to deliver the consumable supplies.

In addition, by the automatic purchase order, as long as it is satisfactory, the operations of A-2 through A-4 may be omitted.

B. Panel-Operation Purchase Order

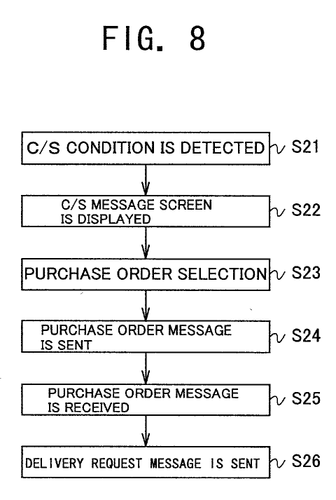

A description will be given of a panel-operation purchase order process that is performed by the consumable-supplies purchase order system of the present invention with reference to FIG. 8.

B-1. When the C/S condition detecting/managing unit 28 detects that the quantity of the consumable supplies in the customer equipment is less than the reference quantity (S21 of FIG. 8), the customer equipment displays the indication that the specified consumable supplies run short, on the operation panel, and displays the purchase order message concerning the specific consumable supplies on the operation panel (S22).

B-2. The customer places a purchase order for the consumable supplies based on the displayed purchase order message by pressing the purchase order button (S23).

B-3. The customer equipment transmits the purchase order information related to the consumable supplies, to the purchase order processing apparatus (S24).

B-4. The purchase-order processing apparatus 80 receives the purchase order message from the customer equipment (S25), and transmits a delivery request message to the supply center 90 (S26).

Moreover, there is another ordering method (customer-initiating purchase order) that can be selected by the customer to place a purchase order for consumable supplies arbitrarily, even when the two methods of the above items A and B are not selected.

C. Customer-Initiating Purchase Order

C-1. The customer presses the C/S purchase order key 37 of the operation panel 36, and a purchase order input message appears on the display of the operation panel 36.

C-2. The customer places a purchase order for consumable supplies arbitrarily based on the displayed purchase order input message.

C-3. The purchase order information related to the consumable supplies is transmitted from the customer equipment to the purchase order processing apparatus 80.

In the above-mentioned case, the customer can place a purchase order about arbitrary consumable supplies, such as the consumable supplies of the copier or office consumable supplies.

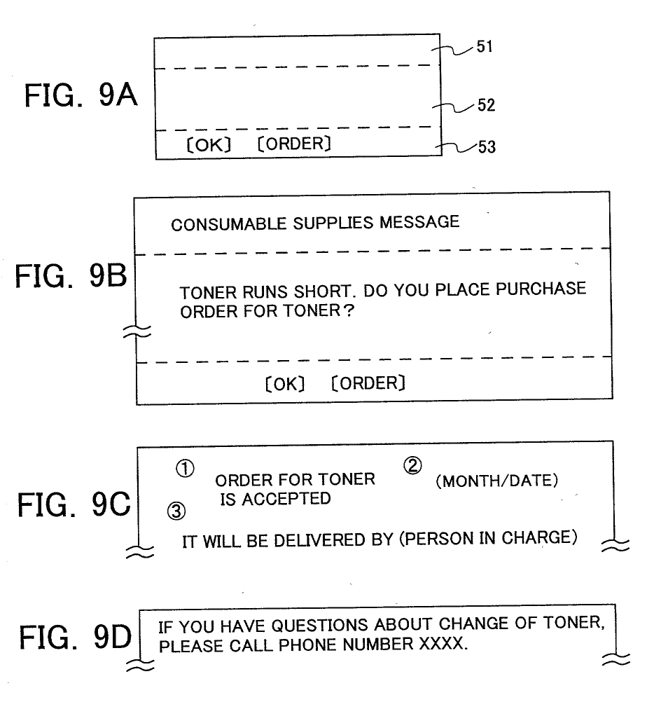

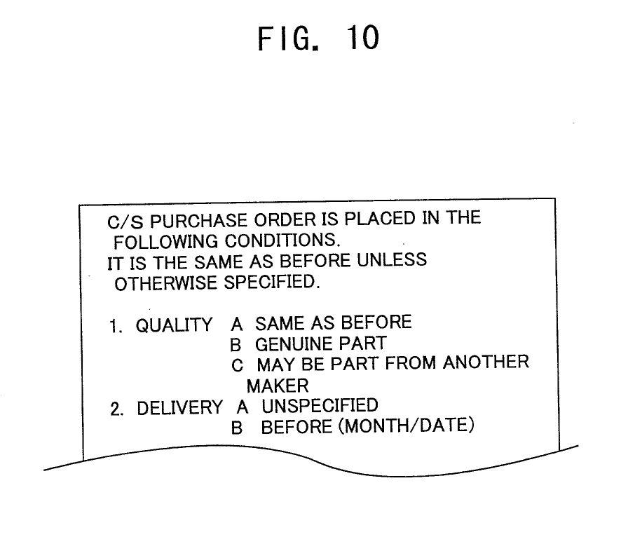

FIG. 9A through FIG. 9D show examples of message on the display of the operation panel of the customer equipment.

The display of the touch panel 31 where various messages are displayed, is divided into three portions: a service item display portion 51, a message content display portion 52, and an instructions input portion 53 as shown in FIG. 9A.

For example, when the C/S condition detecting/managing unit 28 detects that the quantity of the consumable supplies in the customer equipment concerned is less than the predetermined reference quantity, the indication “consumable supplies message” as shown in FIG. 9B appears in the service item display portion 51 of the touch panel 31. Moreover, the indication “Toner runs short. Do you place purchase order for toner?” is displayed in the message content display portion 52 of the touch panel 31. Furthermore, the “OK” and “Order” buttons are displayed in the instructions input portion 53 of the touch panel 31.

The “OK” button is touched by the customer when the customer understands the fact that the toner runs short but intends not to place a purchase order for toner. Moreover, the “Order” button is touched by the customer when the customer intends to place a purchase order for toner. When the “Order” button is touched by the customer, the purchase order message will be transmitted from the customer equipment to the purchase-order processing apparatus 80 as described above.

In addition, the purchase order processing apparatus 80 transmits the order-reception message to the customer equipment after the purchase order message from the customer equipment is received. At this time, for example, the indication-1 “order for toner is accepted”, the indication-2 related to the date of delivery and the indication-3 related to the delivery person are displayed on the display of the touch panel 31 as shown in FIG. 9C.

Further, in some circumstances, the guide information “If you have questions about the change of toner, please call phone number XXXX” may be displayed on the display of the touch panel as shown in FIG. 9D.

Moreover, the purchase order of the consumable supplies concerning other equipment or the common consumable supplies can be requested from the customer equipment by using the consumable-supplies purchase order system of the present invention.

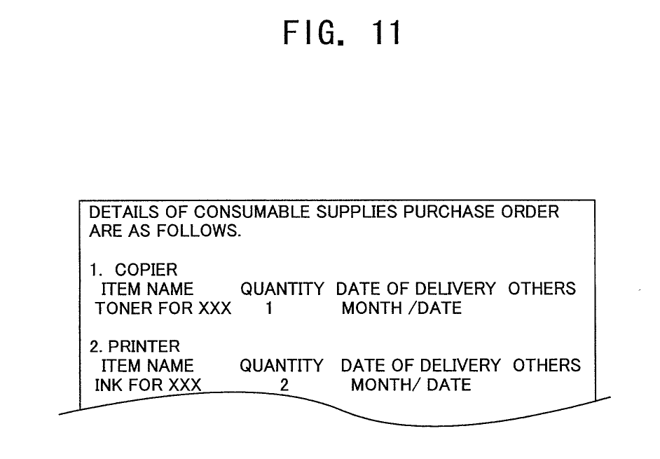

Moreover, the quality, the time of delivery, etc. can also be displayed on the display of the touch panel 31. For example, the message related to the quality and the delivery as shown in FIG. 10 may be displayed. In this case, the customer can choose one of such options for every item of the consumable supplies. In addition, if no purchase order option is specified, the consumable supplies that are the same as those of the previous purchase order will be delivered.

Accordingly, the customer on the operation panel 31 is requested to select or specify at least one of the quality level, the price, the manufacturer and the delivery time related to the consumable supplies, in response to the purchase order message on the display of the touch panel 31.

When the purchase order information is displayed on the touch panel 31 of the customer equipment, those detailed information can be displayed by touching the purchase order information portion of the touch panel 31. For example, by touching the purchase order information portion in which the purchase order information is displayed, the detailed purchase order information will appear on the display of the touch panel 31. For example, at the current state of the purchase order, the details of the consumable supplies that are not yet delivered may be displayed, or the previous purchase order history information may be displayed. FIG. 11 shows an example of the detailed purchase order message related to the consumable supplies that are not yet delivered.

Next, a description will be given of the purchase-order processing apparatus according to the present invention.

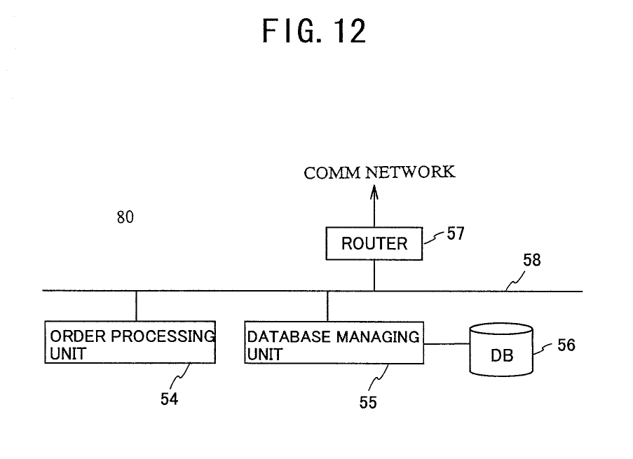

FIG. 12 shows one embodiment of the purchase order processing apparatus 80. As shown in FIG. 12, the purchase order processing apparatus 80 includes a database managing unit 55, a database 56, a router 57, a LAN 58, and a purchase-order processing unit 54.

In addition, the purchase order processing apparatus 80 may be configured so that it further includes a customer equipment information collecting/managing unit, a customer equipment malfunction notification processing unit, a customer equipment fixture/supply notification processing unit, a customer equipment alarm processing unit, and a customer equipment failure processing unit. Consequently, the purchase order processing apparatus 80 may function as a customer support center which offers customer support based on the information about the customer equipment.

The router 57 has a routing function that provides selectively one of the interface between the apparatus 80 and the communication network 10 and the interface between the apparatus 80 and the supply center 90 as in the system of FIG. 1.

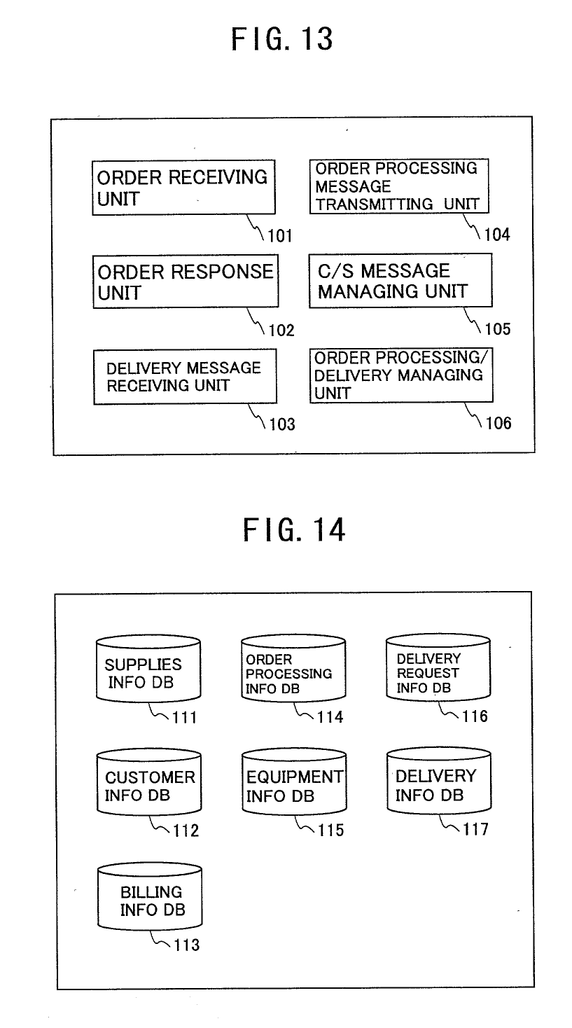

The purchase-order processing unit 54 includes various processing units shown in FIG. 13, and performs various functions including a purchase order receiving function, a purchase order response function, a delivery message receiving function, an order-reception message transmitting function, a C/S message managing function, and a purchase order processing/delivery managing function.

The purchase order receiving unit 101 receives the purchase order information, related to the consumable supplies, which is sent by the customer equipment 60.

The order response unit 102 transmits the order-reception message, indicating that the purchase order information related to the consumable supplies is received, to the customer equipment 60.

The delivery message receiving unit 103 receives the delivery message from the supply center 90, the delivery message indicating that the consumable supplies are delivered to the customer.

The order processing message transmitting unit 104 transmits a delivery request message to the supply center 90 after the purchase order information from the customer equipment 60 is received, the delivery request message requesting the supply center 90 to deliver the consumable supplies to the customer.

The C/S message managing unit 105 manages the information about the consumable supplies.

For every customer, the purchase order processing/delivery managing unit 106 always monitors the state of the purchase order processing and the state of the delivery of consumable supplies, and performs the management processing.

The database managing unit 55 manages the database 56. As shown in FIG. 14, in the database 56, consumable-supplies information, customer information, billing information, order-processing information, customer equipment information, delivery request information, and delivery information are stored.

The consumable-supplies information database 111 stores the information related to the consumable supplies which the purchase order processing apparatus 80 deals with. For every consumable supplies, the delivery contractor, the related customer equipment, the customer, the delivery period, the price, and so on, are stored in the database 111.

The customer information database 112 stores the information related to the customers who contracted with the consumable supplies supplier. For every customer, the name of the customer, the address, the telephone number, the consumable-supplies administrator, the contents of the contract, the contents of the consumable supplies being ordered, and the contents of the previous purchase orders are stored in the database 112.

The billing information database 113 stores the contents of the bill to the customer and the contents of the previous bills. The purchase-order processing information database 114 stores the contents of the order reception and the contents of the previous order receptions for every customer.

The customer equipment information database 115 stores the information related to the customer equipment. For every customer equipment, the related consumable supplies and the amount of the related consumable supplies used in the customer equipment within a predetermined time are stored in the database 115.

The delivery request information database 116 stores the situation of the delivery request and the contents of the previous delivery requests for every supply center.

The delivery information database 117 stores the situation of the delivery of the consumable supplies and the contents of the previous delivery for each customer or each supply center.

A description will be given of a delivery request message which is transmitted to a customer engineer terminal by the purchase-order processing apparatus 80.

The purchase-order processing apparatus 80 notifies the contents of the purchase order to the customer engineer in charge of the requesting customer when the purchase order is received at the apparatus 80.

In addition, the sending of a delivery request message to the customer engineer in charge is performed by, for example, transmitting an E-mail to the cellular phone (or the CE terminal 70) which is owned by the customer engineer. At this time, the customer engineer is notified of the customer name, the customer address, the customer telephone number, the equipment model and machine number, and the consumable supplies being ordered. However, the present invention is not limited to this embodiment (an E-mail). It is possible to use another method of sending of a delivery request message to the customer engineer.

By receiving this delivery request message, the customer engineer can grasp the detailed information about the consumable supplies ordered by the customer. When the time to visit the customer site just precedes the time the customer engineer receives the delivery request message and the related consumable supplies are available, the customer engineer can send the consumable supplies to the customer site by himself.

In order for the customer to place a consumable-supplies purchase order more easily, the customer equipment may include a consumable-supplies purchase order panel 61 which is provided for the purpose of the consumable-supplies purchase order. In this case, it is not necessary that the purchase order check portion 3113, the consumable-supplies purchase order portion 3114, and the consumable-supplies purchase order key 37 shown in FIG. 6 are provided in the customer equipment.

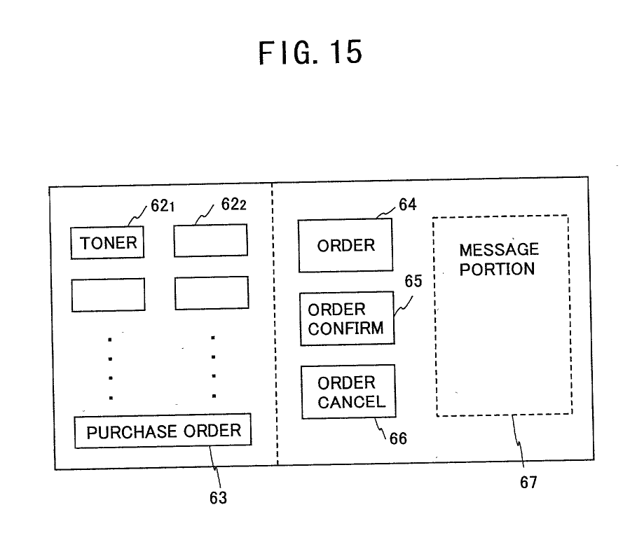

The consumable-supplies purchase order panel 61 shown in FIG. 15 is formed at a suitable location on the operation panel 36. In addition, the operation panel control unit 30 performs control of the consumable-supplies purchase order panel 61 in this embodiment.

The consumable-supplies purchase order panel 61 includes consumable-supplies display portions 62, a purchase order information display portion 63, a purchase order button 64, a purchase order confirm button 65, a purchase order cancel button 66, and a message portion 67.

When the C/S condition detecting/managing unit 28 detects that the quantity of the toner is less than the reference quantity, the toner display portion 621 of the consumable-supplies purchase order panel 61 is made to turn on. By the turn-on state of the display portion 621, the customer can know that the toner runs short. A purchase order for the toner is placed when the customer presses the purchase order button 64, and the purchase order information about the toner is transmitted to the purchase order processing apparatus 80.

The purchase-order processing apparatus 80 transmits an order-reception message, indicating that the purchase order information is received at the apparatus 80, to the requesting customer equipment when the purchase order information is received. The customer equipment receives this information and blinks the purchase order confirmation button 65. The blinking state of the purchase order confirmation button 65 is returned to the normal state when the customer presses the button 65. Then, a purchase order display is performed in the purchase order portion 63, which indicates that the toner is currently ordered.

Moreover, in the message portion 67 of the panel 61, the guide information needed for the customer to perform a consumable-supplies purchase order and operation is displayed.

In addition, the consumable-supplies purchase order panel 61 may be made of a liquid crystal display (LCD) which is configured into a touch panel.

As described in the foregoing, according to the present invention, the customer is allowed to place a purchase order for consumable supplies quickly and exactly, and to reduce the useless stock of consumable supplies.

The present invention is not limited to the above-described embodiments, and variations and modifications may be made without departing from the scope of the present invention.

Further, the present invention is based on Japanese priority application No. 2001-179269, filed on Jun. 13, 2001, the entire contents of which are hereby incorporated by reference.

What is claimed is

1. A consumable-supplies purchase order method for a system including a customer equipment and a purchase-order processing apparatus that are connected via a communication network, comprising the steps of:
detecting at a consumable-supplies condition detection unit of the customer equipment whether a quantity of consumable supplies in the customer equipment is less than a given reference quantity;
transmitting a consumable-supplies purchase order from the customer equipment to the purchase-order processing apparatus when the quantity of the consumable supplies is less than the reference quantity;
receiving an order-reception message sent by the purchaseorder processing apparatus when the purchase order is received at the purchase-order processing apparatus; and
displaying an indication of completion of the purchase order on an operation panel of the customer equipment after the orderreception message is received.

2. A consumable-supplies purchase order method for a system including a customer equipment and a purchase-order processing apparatus that are connected via a communication network, comprising the steps of:
providing an operation panel having a display and a purchaseorder button in the customer equipment;
detecting at a consumable-supplies condition detection unit of the customer equipment whether a quantity of consumable supplies in the customer equipment is less than a given reference quantity;
displaying a purchase-order message related to the consumable-supplies, on the display when the quantity of the consumable supplies is less than the reference quantity;
setting the purchase-order button in an active state; and
transmitting a consumable-supplies purchase order from the customer equipment to the purchase-order processing apparatus when the purchase-order button is pressed.

3. A consumable-supplies purchase order method for a system including a customer equipment and a purchase-order processing apparatus that are connected via a communication network, comprising the steps of:
providing an operation panel having a display in the customer equipment;
detecting at a consumable-supplies condition detection unit of the customer equipment whether a quantity of consumable supplies in the customer equipment is less than a given reference quantity;
displaying a purchase-order message related to the consumable-supplies, on the display when the quantity of the consumable supplies is less than the reference quantity; and
transmitting a consumable-supplies purchase order from the customer equipment to the purchase-order processing apparatus when a purchase-order operation is performed on the operation panel in response to the displayed message.

4. A consumable-supplies purchase order method for a system including a customer equipment and a purchase-order processing apparatus that are connected via a communication network, comprising the steps of:
providing an operation panel having a display in the customer equipment;
displaying a purchase-order message related to consumablesupplies in the customer equipment, on the display when a purchaseorder start operation is performed on the operation panel; and
transmitting a consumable-supplies purchase order from the customer equipment to the purchase-order processing apparatus when a purchase-order operation is performed on the operation panel in response to the displayed message.

5. The method of claim 2, further comprising the step of requesting a customer on the operation panel to select or specify at least one of a quality level, a price, a manufacturer and a delivery time related to the consumable supplies, in response to the purchase-order message on the display.

6. The method of claim 2 further comprising the step of displaying a record of a newest purchase order on either the operation panel or the display when the purchase-order button is pressed.

7. The method of claim 6 wherein the displaying of the record of the newest purchase order is continued until a delivery of the consumable supplies is performed.

8. The method of claim 6 wherein the display is a touchsensitive display, and the display is configured to display detailed purchase-order information thereon when the purchase-order message is displayed and a portion of the purchase-order information is touched.

9. The method of claim 1 wherein the system further includes a supply center connected to the network, further comprising the step of transmitting a delivery request message from the purchase order processing apparatus to a customer engineer terminal of the supply center related to the requesting customer after the purchase order from the customer equipment is received at the purchase order processing apparatus.

10. A consumable-supplies purchase order system including a customer equipment and a purchase-order processing apparatus that are connected via a communication network, the customer equipment comprising:
a consumable-supplies condition detection unit detecting whether a quantity of consumable supplies in the customer equipment is less than a given reference quantity;
a transmission unit transmitting a consumable-supplies purchase order from the customer equipment to the purchase-order processing apparatus when the detection unit detects that the quantity of the consumable supplies is less than the reference quantity;
a receiving unit receiving an order-reception message sent by the purchase-order processing apparatus when the purchase order is received at the purchase-order processing apparatus; and
a displaying unit displaying an indication of completion of the purchase order on an operation panel of the customer equipment after the order-reception message is received.

11. A consumable-supplies purchase order system including a customer equipment and a purchase-order processing apparatus that are connected via a communication network, the customer equipment comprising:
an operation panel having a display and a purchase-order button in the customer equipment;
a consumable-supplies condition detection unit detecting whether a quantity of consumable supplies in the customer equipment is less than a given reference quantity;
a displaying unit displaying a purchase-order message related to the consumable-supplies, on the display when the detection unit detects that the quantity of the consumable supplies is less than the reference quantity;
a setting unit setting the purchase-order button in an active state; and
a transmission unit transmitting a consumable-supplies purchase order from the customer equipment to the purchase-order processing apparatus when the purchase-order button is pressed.

12. A consumable-supplies purchase order system including a customer equipment and a purchase-order processing apparatus that are connected via a communication network, the customer equipment comprising:
an operation panel having a display in the customer equipment;
a consumable-supplies condition detection unit detecting whether a quantity of consumable supplies in the customer equipment is less than a given reference quantity;
a displaying unit displaying a purchase-order message related to the consumable-supplies, on the display when the detection unit detects that the quantity of the consumable supplies is less than the reference quantity; and
a transmission unit transmitting a consumable-supplies purchase order from the customer equipment to the purchase-order processing apparatus when a purchase-order operation is performed on the operation panel in response to the displayed message.

13. A consumable-supplies purchase order system including a customer equipment and a purchase-order processing apparatus that are connected via a communication network, the customer equipment comprising:
an operation panel having a display in the customer equipment;
a displaying unit displaying a purchase-order message related to consumable-supplies in the customer equipment, on the display of the operation panel when a purchase-order start operation is performed on the operation panel; and
a transmission unit transmitting a consumable-supplies purchase order from the customer equipment to the purchase-order processing apparatus when a purchase-order operation is performed on the operation panel in response to the displayed message.

14. The system of claim 10 wherein the purchase order processing apparatus comprises a database in which at least one of customer information, equipment information, consumable-supplies information, order-reception information and delivery information is stored.

15. A customer equipment which is connected to a purchase-order processing apparatus via a communication network in a consumable-supplies purchase order system, the customer equipment comprising:
a main controller;
a communication controller; and
a consumable-supplies condition detection unit detecting whether a quantity of consumable supplies in the customer equipment is less than a given reference quantity;
wherein the main controller causes the communication controller to transmit a consumable-supplies purchase order from the customer equipment to the purchase-order processing apparatus when the detection unit detects that the quantity of the consumable supplies is less than the reference quantity.

16. The customer equipment of claim 15 further comprising:
an operation panel having a display in the customer equipment; and
an operation panel controller controlling the operation panel,
wherein the main controller causes the operation panel controller to display an indication of completion of the purchase order on the display of the operation panel when an order-reception message sent by the purchase-order processing apparatus is received at the communication controller.

17. A customer equipment which is connected to a purchase-order processing apparatus via a communication network in a consumable-supplies purchase order system, the customer equipment comprising:
a main controller;
a communication controller;
a consumable-supplies condition detection unit detecting whether a quantity of consumable supplies in the customer equipment is less than a given reference quantity;
an operation panel having a display and a purchase-order button in the customer equipment; and
an operation panel controller controlling the operation panel;
wherein the main controller causes the operation panel controller to display a purchase-order message related to the consumable-supplies, on the display when the detection unit detects that the quantity of the consumable supplies is less than the reference quantity, the main controller setting the purchase-order button in an active state,
wherein the main controller causes the communication controller to transmit a consumable-supplies purchase order from the customer equipment to the purchase-order processing apparatus when the purchase-order button is pressed.

18. A customer equipment which is connected to a purchase25 order processing apparatus via a communication network in a consumable-supplies purchase order system, the customer equipment comprising:
a main controller;
a communication controller;
an operation panel having a display in the customer equipment;
an operation panel controller controlling the operation panel; and
a consumable-supplies condition detection unit detecting whether a quantity of consumable supplies in the customer equipment is less than a given reference quantity;
wherein the main controller causes the operation panel controller to display a purchase-order message related to the consumable-supplies, on the display when the detection unit detects that the quantity of the consumable supplies is less than the reference quantity,
wherein the main controller causes the communication controller to transmit a consumable-supplies purchase order from the customer equipment to the purchase-order processing apparatus when a purchase-order operation is performed on the-operation panel in response to the displayed message.

19. A customer equipment which is connected to a purchaseorder processing apparatus via a communication network in a consumable-supplies purchase order system, the customer equipment comprising:
a main controller;
a communication controller;
a consumable-supplies condition detection unit detecting whether a quantity of consumable supplies in the customer equipment is less than a given reference quantity;
an operation panel having a display in the customer equipment; and
an operation panel controller controlling the operation panel;
wherein the main controller causes the operation panel controller to display a purchase-order message related to consumable-supplies in the customer equipment, on the display when a purchase-order start operation is performed on the operation panel,
wherein the main controller causes the communication controller to transmit a consumable-supplies purchase order from the customer equipment to the purchase-order processing apparatus when a purchase-order operation is performed on the operation panel in response to the displayed message.

20. The customer equipment of claim 17 wherein the main controller causes an operator on the operation panel to select or specify at least one of a quality level, a price, a manufacturer and a delivery time related to the consumable supplies, in response to the purchase-order message on the display.

21. The customer equipment of claim 17 wherein the main controller causes the operation panel controller to display a-record of a newest purchase order on either the operation panel or the display when the purchase-order button is pressed.

22. The customer equipment of claim 21 wherein the main controller continuously performs the displaying of the record of the newest purchase order until a delivery of the consumable supplies is performed.

23. The customer equipment of claim 21 wherein the display is a touch-sensitive display, and the main controller and the operation panel controller are configured to display detailed purchase-order information thereon when the purchase-order message is displayed and a portion of the purchase-order information is touched.

24. A purchase-order processing apparatus which is connected to a customer equipment via a communication network in a consumable-supplies purchase order system, the purchase-order processing apparatus comprising:
a purchase-order receiving unit receiving a consumablesupplies purchase order from the customer equipment; and
an order response unit transmitting an order-reception message to the customer equipment in response to the purchase order,
wherein the response unit transmits an order-reception message to the customer equipment when the purchase order from the customer equipment is received by the receiving unit, the orderreception message indicating the reception of the purchase order by the purchase order processing apparatus.

25. The apparatus of claim 24 further comprising a database in which at least one of customer information, equipment information, consumable-supplies information, purchase-order information and delivery information is stored.

26. The apparatus of claim 24 further comprising an orderprocessing message transmitting unit which transmits a delivery request message to a customer engineer terminal of a supply center related to the customer equipment after the purchase order from the customer equipment is received at the purchase order processing apparatus.
